(19) United States
(12) Patent Application Publication
(10) Pub. No.: US 2005/0189055 A1
(43) Pub. Date: Sep. 1, 2005

(54) Lampshade handbag

(75) Inventor: Stacey L. High, Boca Raton, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Stacey High, Inc.

(21) Appl. No.: 10/790,503

(22) Filed: Mar. 1, 2004

(51) Int. Cl. F21V 29/00; A45C 13/26; A45C 13/36

(52) U.S. Cl. 150/127; 150/107

(57) ABSTRACT

A method, system and article of manufacture for a lampshade handbag. A lampshade handbag can include a chamber having a lampshade having a closed end and an open end; and, carrying means affixed to the lampshade. In a preferred embodiment of the present invention, the open end can have a diameter which exceeds a diameter of the closed end. In any case, a seal can be formed at the open end of the chamber. Moreover, at least one lampshade finial can be affixed to the lampshade, to the seal, or both. Similarly, a lampshade pull-chain can be attached to the lampshade, the seal, or both. Notably, the seal can include a seal selected from the group consisting of a removable top, a draw-string, a snap, a button and a zipper, to name a few.

### BACKGROUND OF THE INVENTION

1. Statement of the Technical Field

The present invention relates to handbags and purses.

2. Description of the Related Art

Purses and handbags, collectively “handbags”, date from medieval Europe even though Egyptian hieroglyphs show pouches carried about the waist. Originally carried by men and termed “pockets”, the medieval purse consisted of little more than a pouch intended to carry scented potpourri, orange rinds, flints or coin. The earliest pockets were hung by thongs from the back of a man's girdle and often could be cut from behind by thieves who knew how to capitalize on a friendly pat on the back; hence the name “cut purse”. During the Renaissance, both men and women adopted pocket carrying and the use of a “sack” become much of a status symbol as the sacks become larger to carry the increasing wealth of the populace. Over time, sacks become more and more ornate in design, as well.

Though the 18th century gave rise the concealment of pockets, by the 19th century, subsequent to the French Revolution, the ornate and complex clothing of the time prohibited the incorporation of pockets to carry small belongings. Consequently, separate handbags, then referred to as “reticules”, which were designed to be carried in the open became an important functional and fashionable accessory to the dress both of men and women. Though the ensuing decades would lead to a decline in handbag carrying, by the 20th century, the skimpy clothing of the conventional female wardrobe established the handbag as an indispensable woman's accessory item.

Since the early twentieth century, all handbags enjoy a few common structural elements. First, the handbag always includes a chamber in which personal articles can be stowed. Second, the handbag always includes a carrying means, whether a strap, or a handle. In fact, several contemporary designs include a set of straps so that the handbag can be worn as a handbag. Moreover, the fanny pack—a form of handbag—similarly has enjoyed some success due to the set of straps affixed to the handbag which are designed to secure the handbag about the waist of a wearer. Notably, some handbags include chambers which can be sealed while other handbags include chambers which remain open and accessible. Generally, the chamber seal of the handbag can include a drawstring, snap, or zipper though other fasteners have been incorporated as well.

Twentieth century technology has opened up a treasure of textures and materials from space age synthetics to hand-woven straws. There are rain-proof bags for stormy days, sturdy totes for the beach, delicate fabrics for evening, and squashy shoulder bags for casual wear. In short, a fascinating variety of handbags have arisen for every mood, every outfit and every occasion. In this regard, the fashionable and ornamental features of a handbag seem to have eclipsed the importance of the structure of the bag itself. In this regard, in a multi billion dollar industry, the freshness and creativity of a handbag often can spell profit or loss for the manufacturer of a new handbag.

### SUMMARY OF THE INVENTION

The present invention provides a novel and non-obvious system, method and article of manufacture for a lampshade handbag. In accordance with the present invention, a lampshade handbag can include a chamber having a lampshade having a closed end and an open end; and, carrying means affixed to the lampshade. In a preferred embodiment of the present invention, the open end can have a diameter which exceeds a diameter of the closed end, although in other embodiments the open end can have a diameter which equals or falls short of the diameter of the closed end. In any case, a seal can be formed at the open end of the chamber. Moreover, optionally at least one lampshade finial can be affixed to the lampshade, to the seal, or both. Similarly, optionally a lampshade pull-chain can be attached to the lampshade, the seal, or both. Notably, the seal can include a seal selected from the group consisting of a removable top, a draw-string, a snap, a button and a zipper.

A lampshade manufacturing method can include the steps of coupling carrying structure to a lampshade; and, sealing a closed end of the lampshade. The coupling step can include the step of coupling a carrying strap to the lampshade. Alternatively, the coupling step can include the step of coupling a carrying handle to the lampshade. In either case, the method further can include the step of attaching a seal to an open end of the lampshade. Optionally, the method can include the step of affixing at least one finial to the lampshade or to the seal. Similarly, the method can include the step of affixing at least one lampshade pull chain to the lampshade or the seal. Finally, the method can include the step of coating the lampshade with a decorative fabric.

In accordance with the present invention, a lampshade handbag system further can be provided. The system can include two or more different lampshade handbags in a collection of lampshade handbags. Each of the different lampshade handbags in the collection can have a differently shaped lampshade as a handbag chamber. Also, each of the different lampshade handbags in the collection further can have different lampshade finials affixed to corresponding differently shaped lampshades.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a lampshade handbag; and,

FIGS. 2A, 2B and 2C are top views of a lampshade handbag, each depicting a different seal over an open end of the lampshade handbag of FIG. 1; and,

FIG. 3 is a flow chart illustrating a process for constructing the lampshade handbag of FIG. 1.

### DETAILED DESCRIPTION OF THE PREFERRED EMBODIMENTS

The present invention is a lampshade handbag. In accordance with the present invention, a handbag can be constructed of a lampshade. The lampshade can be coated in a decorative fabric. One open end of the lampshade can be sealed forming a closed end, while a seal can be formed at the other open end. Carrying structure, for example a strap or handle, can be affixed either to the lampshade or the seal. Additionally, optionally at least one finial can be affixed either to the lampshade or seal. Finally, optionally one or more decorative pull chains can be affixed either to the lampshade or the seal.

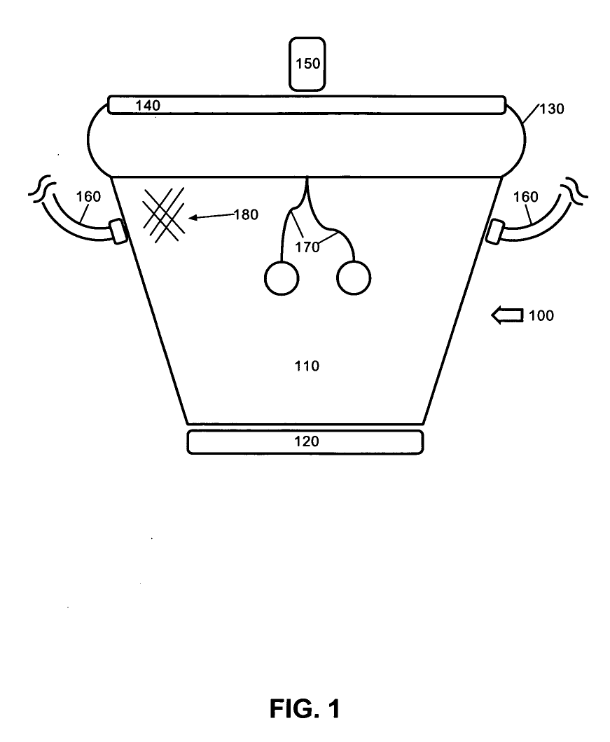

In more particular illustration, FIG. 1 is a schematic illustration of a lampshade handbag. As shown in FIG. 1, a lampshade handbag 100 can include a lampshade 110. The lampshade can be coated with a decorative fabric 180. A bottom end of the lampshade 110 can be sealed using a bottom 120. Optionally, an opposite end of the lampshade 110 can be fitted for a seal 140. In this regard, the seal 140 can include any structure intended to restrict the entry and egress of articles to and from the interior portion of the lampshade 110. To that end, the seal 140 can include, as an example, a top coupled to the lampshade by chains, string or wire 130, sealable fabric through the operation of a drawstring, a zipper, one or more buttons, snaps and the like.

Carrying structure 160 can be coupled to the lampshade 110. The carrying structure 160 can include any device intended to facilitate the carrying of the handbag 100 by a person, such as a handle or strap. Notably, in an alternative aspect of the invention, the carrying structure 160 can be coupled not to the lampshade 110, but to the seal 140, particularly where the seal 140 is a top as shown in FIG. 1. Optionally, one or more lampshade finials 150 can be affixed to the seal 140, the lampshade 110, or both. Moreover, one or more lampshade pull chains 170 can be affixed to the seal 140, the lampshade 110, or both.

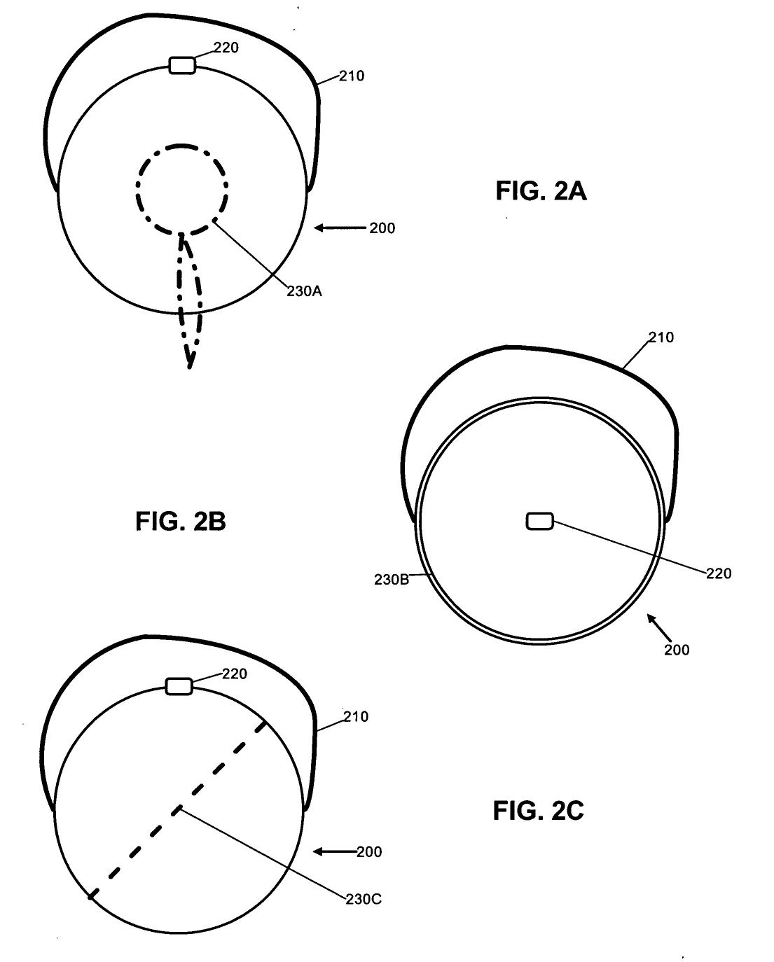

Turning now to FIGS. 2A, 2B and 2C, each illustrate a top view of the lampshade handbag 100 of FIG. 1. In particular, each illustration depicts a different seal 140 over an open end of the lampshade 100 handbag of FIG. 1. Referring first to FIG. 2A, a handbag 200 can include carrying structure 210 (shown as a strap) along with at least one finial 220. A fabric seal which can be opened and closed by way of a drawstring 230A performs the sealing function of the seal 140 of FIG. 1. By comparison, as shown in FIG. 2B, a top 230B can perform the function of the seal 140 of FIG. 1. Finally, as yet another example, in FIG. 2C a zipper 230C can perform the function of the seal 140 of FIG. 1. It will be recognized by the skilled artisan, however, that the foregoing exemplary embodiments are not the exclusive means by which the open end of the lampshade 110 of FIG. 1 can be sealed and other similarly functional elements can be substituted for those illustrated herein.

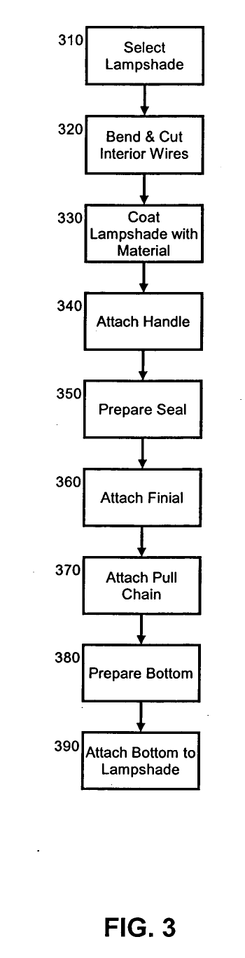

In any event, turning now to FIG. 3, a flow chart is shown which illustrates a process for constructing the lampshade handbag of FIG. 1. Beginning in block 310, a lampshade can be selected for use in constructing the handbag. The lampshade can be selected from a set of lampshades manufactured for incorporation with an existing lamp or lamps, or the lampshade can be selected from a set of lampshades fabricated specifically for the purpose of incorporation in a lampshade handbag. In any case, in block 320, any internal wiring intended to facilitate coupling between the lampshade and a lamp can either be bent or removed to suit the use of the internal chamber of the lampshade as a carrying pouch.

In block 330, the lampshade can be coated with a decorative material, such as any fabric or foil. In block 340, a carrying structure can be affixed to the lampshade, including as an example, a strap or a handle. In block 350, a seal can be prepared and attached to the lampshade. Notably, the seal can range from a separate top to affixed fabric which can be opened or closed by way of a drawstring, buttons, a zipper or snaps, to name a few. In any case, in an optional embodiment of the present invention, the carrying structure can be affixed not to the lampshade, but to the seal. Moreover, in block 360 one or more lampshade finials can be affixed to the seal, or to the lampshade handbag (or both).

In block 370, one or more decorative pull chains can be affixed to the seal or to the lampshade (or both). Finally, in blocks 380 and 390, a bottom can be prepared for the lampshade and attached so as to seal the bottom end of the lampshade. Significantly, this invention can be embodied in other specific forms without departing from the spirit or essential attributes thereof, and accordingly, reference should be had to the following claims, rather than to the foregoing specification, as indicating the scope of the invention.

1. A lampshade handbag article of manufacture comprising:
a chamber comprising a lampshade having a closed end and an open end; and,
carrying means affixed to said lampshade.

2. The article of manufacture of claim 1, further comprising a seal at said open end of said chamber.

3. The article of manufacture of claim 1, further comprising at least one lampshade finial affixed to said lampshade.

4. The article of manufacture of claim 2, further comprising at least one lampshade finial affixed to said seal.

5. The article of manufacture of claim 1, further comprising a lampshade pull-chain attached to said lampshade.

6. The article of manufacture of claim 2, further comprising a lampshade pull-chain attached to said seal.

7. The article of manufacture of claim 2, wherein said seal comprises a seal selected from the group consisting of a removable top, a draw-string, a snap, a button and a zipper.

8. The article of manufacture of claim 1, wherein said open end has a diameter which exceeds a diameter of said closed end.

9. A lampshade manufacturing method comprising the steps of:
coupling carrying structure to a lampshade; and,
sealing a closed end of said lampshade.

10. The method of claim 9, wherein said coupling step comprises the step of coupling a carrying strap to said lampshade.

11. The method of claim 9, wherein said coupling step comprises the step of coupling a carrying handle to said lampshade.

12. The method of claim 9, further comprising the step of attaching a seal to an open end of said lampshade.

13. The method of claim 9, further comprising the step of affixing at least one finial to said lampshade.

14. The method of claim 12, further comprising the step of affixing at least one finial to said seal.

15. The method of claim 9, further comprising the step of coating said lampshade with a decorative fabric.

16. The method of claim 9, further comprising the step of affixing at least one lampshade pull chain to said lampshade.

17. The method of claim 12, further comprising the step of affixing at least one lampshade pull chain to said seal.

18. A lampshade handbag system comprising a plurality of different lampshade handbags, each of said different lampshade handbags having a differently shaped lampshade as a handbag chamber.

19. The system of claim of claim 13, wherein each of said different lampshade handbags further have different lampshade finials affixed to corresponding differently shaped lampshades.
